(19) United States
(12) Patent Application Publication
(10) Pub. No.: US 2012/0142956 A1
(43) Pub. Date: Jun. 7, 2012

(54) PROCESS FOR REACTING HYDROXYL COMPOUNDS WITH LINEAR, BRANCHED OR CYCLIC POLYALKYLSILOXANES

(75) Inventor: Thomas Neumann, Bochum (DE)

(73) Assignee: EVONIK GOLDSCHMIDT GMBH, Essen (DE)

(21) Appl. No.: 13/306,439

(22) Filed: Nov. 29, 2011

(30) Foreign Application Priority Data
Dec. 1, 2010 (DE) DE102010062244.3

(51) Int. Cl. C07F 7/18

(52) U.S. Cl. 556/462

(57) ABSTRACT

A process for preparing organopolysiloxanes by reacting linear siloxane compounds (II) and/or cyclic siloxane compounds (III) with a compound having at least one hydroxyl group R′—OH (IV) where R′ are identical or different organic radicals, which is characterized in that the compounds of the formulae (II), (III) and (IV) are used in such amounts that the molar ratio of silicon atoms in the compounds of the formulae (II) and (III) to OH groups in the compounds of the formula (IV) is from 0.01:1 to 1000:1, and in that the reaction is performed at a temperature of greater than 70° C. to 175° C., and in that the resulting reaction mixture is not treated with an acidic compound.

### FIELD OF THE INVENTION

The present invention is directed to a process for preparing organopolysiloxanes by reacting linear siloxane compounds and/or cyclic siloxane compounds with a compound having at least one hydroxyl group.

### BACKGROUND OF THE INVENTION

In the production of polyurethane foams, it is common to use organopolysiloxanes in which the organic radicals are joined to the siloxane backbone via SiOC bonds. The preparation is effected by reaction of hydroxyl-functional compounds, for example alcohols, especially polyethers, either with chlorosiloxanes in a substitution reaction or with alkoxysiloxanes in a substitution reaction.

The synthesis route via the chlorosiloxanes is particularly disadvantageous since large amounts of HCl gas or hydrochloric acid are formed, which have to be disposed of or used in some other way.

There have recently been descriptions of numerous processes in which organopolysiloxanes in which the organic radicals are joined to the siloxane backbone via SiOC bonds are obtained by reacting, in a dehydrogenating condensation, polysiloxanes having SiH groups (hydrogen siloxanes) with hydroxy-functional compounds. Such a process is described, for example, in DE 10 2005 051 939. The catalyst used in this process is a quaternary ammonium hydroxide. Preferred ammonium hydroxides are, according to DE 10 2005 051 939, selected from tetramethylammonium hydroxide, tetraethylammonium hydroxide, tetrapropylammonium hydroxide, tetraisopropylammonium hydroxide, tetrabutylammonium hydroxide, tetraisobutylammonium hydroxide, tetra-tert-butylammonium hydroxide, tetrapentylammonium hydroxide, tetrahexylammonium hydroxide, tetraheptylammonium hydroxide, tetraoctylammonium hydroxide, benzyltrimethylammonium hydroxide, diethyldimethylammonium hydroxide, methyltripropylammonium hydroxide, N,N,N,N′,N′,N′-hexabutylhexamethylenediammonium hydroxide, tetrakis(2-hydroxyethyl)ammonium hydroxide, tributylmethylammonium hydroxide, triethylmethylammonium hydroxide, trimethylphenylammonium hydroxide, (2-hydroxyethyl)trimethylammonium hydroxide, (2-hydroxyethyl)triethylammonium hydroxide, (2-hydroxyethyl)tripropylammonium hydroxide, (2-hydroxyethyl)tributylammonium hydroxide, hexamethonium hydroxide, dimethyldiethanolammonium hydroxide and mixtures thereof. In each case, the ammonium hydroxide can be in anhydrous solid form, in different degrees of hydration as a solid, dissolved in aqueous or nonaqueous solvents or mixtures of solvents, adsorbed or covalently bonded to carrier substances, or as a dispersion.

A disadvantage of these processes is the use of hydrogen siloxanes as a starting material, since the hydrogen siloxanes first have to be prepared in an inconvenient and costly manner.

There is therefore the need for a process which provides the possibility, proceeding from starting materials which are easy to prepare or are available in large amounts, of obtaining organopolysiloxanes in which the organic radicals are joined to a siloxane backbone via SiOC bonds.

Such a process is the direct reaction of alcohols with siloxanes. M. M. Sprung and F. O. Günther (J. Org. Chem. 1961, 26(2), 552ff,) described the reaction of n-octyl alcohol with some silanols and siloxanes. The reaction, which was called an alcoholysis by the authors, was catalysed using sodium methoxide or p-toluenesulphonic acid. The reaction of hexamethyltrisiloxane (D3) with n-octyl alcohol in the presence of the acidic catalyst affords 1,5-di-n-octyloxyhexamethyltrisiloxane. The reaction of hexamethyltrisiloxane (D3), octamethyltetrasiloxane (D4) and tetradecamethylcycloheptasiloxane (D7) in the presence of alkaline catalyst did not show any effects attributable to ring strains. The molar ratio of alcohol to siloxane compound was set such that sufficient alcohol was available to dissociate each Si—O—Si bond. Good yields of 1,5-di-n-octoxyhexamethyltrisiloxane were obtained when the reaction was stopped after about one third of the theoretically possible conversion.

Silicon-Containing Polymers, The Science and Technology of Their Synthesis and Applications, Kluwer Academic Publishers, Dordrecht/Boston/London, page 22ff. describes the anionic ring-opening polymerization of cyclic siloxanes. The catalysts used are strong organic, inorganic or organometallic bases, for example, those with tertiary ammonium or phosphonium cations. No information is given about the anions used in the bases. No reaction (copolymerization) with compounds having hydroxyl groups is described.

In U.S. Pat. No. 4,261,848, alkoxysiloxanes which are obtained by reaction of a dimethylsiloxane hydrolysate with alcohol in the presence of a basic catalyst, especially KOH, at 100° C. to 150° C. are used as hydraulic oils. The dimethylsiloxane hydrolysate, which comprises cyclic dimethylsiloxanes and linear dimethylsiloxanes having hydroxyl end groups, is obtained by hydrolysis of dimethyldichlorosilane in the presence of hydrochloric acid. To neutralize the base used, H₂CO₃ is added.

Novikova et al. describe, in Kauchuk i Rezina (1986), (5), 22-4, the use of α-alkoxypolydimethylsiloxan-ω-ols as stabilizers for rubber mixtures. The aforementioned compounds are prepared using mixtures of cyclic siloxanes comprising D3, D4 and decamethylcyclopentasiloxane (D5). The catalysts used are α,ω-bis(tetramethylammonium) dimethylsiloxanolate, an aqueous solution of tetramethylammonium hydroxide and an alcoholic solution of KOH. The reaction is effected with a molar ratio of —Si(CH₃)₂O— groups to hydroxyl groups of 4.67 to 1 at 70° C. The by-products obtained are α,ω-alkoxypolydimethylsiloxanes.

### SUMMARY OF THE INVENTION

The present invention provides an alternative process for preparing reaction products of hydroxyl compounds with linear, branched or cyclic polyalkylsiloxanes, which avoids one or more of the disadvantages of the prior art processes. More particularly, the present invention provides an alternative, preferably simple, process for preparing α,ω-organopolydimethylsiloxanes, in which the organic radicals in α and ω positions are joined to the siloxane backbone via SiOC bonds.

In one embodiment of the present invention, a process is provided for preparing compounds of formula (I)

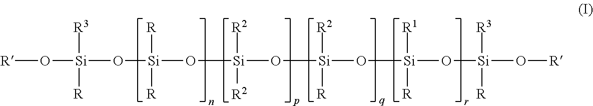

by reacting linear siloxane compounds (II)

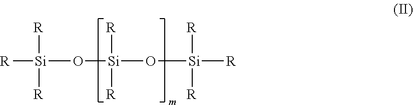

and/or cyclic siloxane compounds (III)

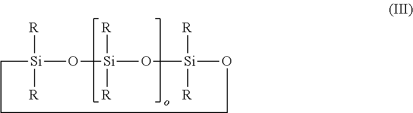

with a compound (IV) having at least one hydroxyl group

R′—OH (IV)

where
R, R′, R¹, R², R³, n, m, o, p, q, and r are each as specified below, in the presence of one or more catalysts selected from quaternary ammonium compounds which have, as anion(s), a carbonate, siloxanolate or hydroxide anion, which is characterized in that the compounds of formulae (II), (III) and (IV) are used in such amounts that the molar ratio of silicon atoms in the compounds of formulae (II) and (III) to OH groups in the compounds of formula (IV) is from 0.001:1 to 1000:1, preferably from 0.01:1 to 500:1, more preferably from 0.05:1 to 300:1, and in that the reaction is performed at a temperature of greater than 70° C. to 175° C., and in that the resulting reaction mixture is not treated with an acidic compound.

The process according to the invention has the advantage that α,ω-organopolydimethylsiloxanes, especially α,ω-alkoxypolydimethylsiloxanes, can be obtained with good yields. A further advantage is that it is possible to dispense with the use of chlorosiloxanes and hydrogen siloxanes.

In the process according to the invention, water is obtained as a reaction (by-)product. Since water is not disruptive in most processing steps, the process product obtained as the distillate can be used further directly.

No HCl is obtained as a reaction (by-)product. This has the advantage that no particular demands have to be made on the materials for the production of the reactors, pumps, etc. used.

The adjustment of the molar ratios of silicon atoms to OH groups can be used to fix the chain lengths of the resulting organopolysiloxanes in a simple manner.

### BRIEF DESCRIPTION OF THE DRAWINGS

FIG. 1 shows an ²⁹Si NMR spectra of a compound prepared according to Example 1 and is in accordance with the present invention.

FIG. 2 shows an ²⁹Si NMR spectra of compound which has been prepared according to Example 2 and is not in accordance with the present invention and thus represents a comparative example.

### DETAILED DESCRIPTION OF THE INVENTION

The process according to the invention is described hereinafter by way of example, without any intention that the invention be restricted to these illustrative embodiments. When ranges, general formulae or compound classes are specified hereinafter, these shall include not only the corresponding ranges or groups of compounds mentioned explicitly, but also all sub-ranges and sub-groups of compounds which can be obtained by selecting individual values (ranges) or compounds. When documents are cited in the context of the present invention, the contents thereof shall be fully incorporated into the disclosure-content of the present invention. When percentages are reported hereinafter, these are percentages by weight unless stated otherwise. When averages are reported hereinafter, these are number averages unless stated otherwise. Unless stated otherwise, the molar mass of the compounds used was determined by gel permeation chromatography (GPC), and the structure of the compounds used by NMR methods, especially by ¹³C and ²⁹Si NMR.

In one embodiment, the present invention provides a process for preparing compounds of formula (I)

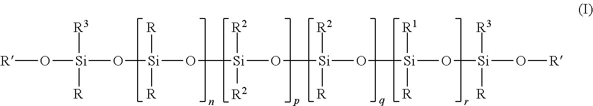

by reacting linear siloxane compounds (II)

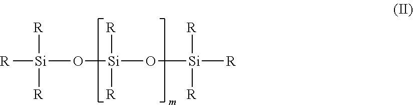

and/or cyclic siloxane compounds (III)

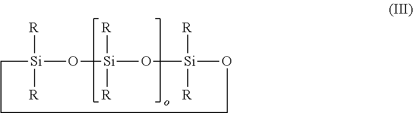

with a compound (IV) having at least one hydroxyl group

R′—OH (IV)

where
R are the same or different and are each saturated or unsaturated hydrocarbyl radicals, preferably alkyl radicals having 1 to 4 carbon atoms, preferably methyl radicals or ethyl radicals, more preferably exclusively methyl radicals,
R′ are the same or different and are each organic radicals, where the two R′ radicals shown in formula (I) may also be a single organic radical,

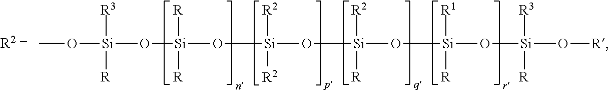

R³ are the same or different and are each R or R¹, preferably R,
R¹ are the same or different and are each alkoxy radicals, preferably methoxy, ethoxy or butoxy radicals, hydrocarbyl radicals having amino groups and/or unsaturated hydrocarbyl radicals,
n=0 to 1000, preferably 1 to 500 and more preferably 5 to 300,
m=0 to 1000, preferably 1 to 500 and more preferably 5 to 100,
o=1 to 5, preferably 2 to 3,
p=0 to 10, preferably 0 or 1,
q=0 to 10, preferably 0 or 1,
r=0 to 20, preferably 0 or 1 to 5,
n′═0 to 1000, preferably 1 to 500 and more preferably 5 to 300,
p′═0 to 10, preferably 0 or 1,
q′=0 to 10, preferably 0 or 1,
r′═0 to 20, preferably 0 or 1 to 5,
with the proviso that the sum of all units with the indices p, q, p′ and q′ is not greater than 15, preferably not greater than 2, more preferably not greater than 1 and especially preferably 0, in the presence of one or more catalysts selected from quaternary ammonium compounds which have, as anion(s), a carbonate, siloxanolate or hydroxide anion, characterized in that the compounds of formulae (II), (III) and (IV) are used in such amounts that the molar ratio of silicon atoms in the compounds of formulae (II) and (III) to OH groups in the compounds of the formula (IV) is from 0.01:1 to 1000:1, preferably from 0.1:1 to 500:1, more preferably from 0.5:1 to 300:1, and in that the reaction is performed at a temperature of greater than 70° C. to 175° C., preferably 90° C. to 175° C., and in that the resulting reaction mixture is not treated with an acidic compound.

The R′ radicals are preferably hydrocarbyl radicals, especially alkyl, aryl, alkylaryl or arylalkyl radicals, which may be substituted by one or more OH groups, amino groups or halogen groups, and which may contain oxygen atoms. Compounds of formula (IV) used with preference are compounds selected from saturated or unsaturated monoalcohols having 2 to 30 carbon atoms, saturated or unsaturated di- or polyols having 2 to 20 carbon atoms, and amino alcohols having 2 to 20 carbon atoms. Preferred compounds of formula (IV) are those in which the R′ radicals are alkyl radicals having 2 to 10, preferably 3 to 7, carbon atoms, which optionally have an OH group or an amino group, or phenyl radicals.

Compounds of formula (IV) which can used be in the present invention are preferably those in which at least one hydroxyl group is a primary or secondary hydroxyl group, preferably a primary hydroxyl group.

Compounds of formula (IV) which can be used in the present invention are more preferably ethanol, propanol, n-butanol, 2-butanol, 2-methylpropanol, N-butylaminoethanol, N,N-dimethylethanolamine, 1,2-butanediol, 1,3-butanediol, 2-phenoxyethanol and/or ethanolamine.

The quaternary ammonium compounds used as catalysts are preferably selected from tetramethylammonium hydroxide (TMAH), tetramethylammonium hydroxide*5H₂O (TMAH*5H₂O), tetrabutylammonium hydroxide, choline hydroxide, tetramethylammonium siloxanolate, tetrahexylammonium hydroxide, tetraethylammonium hydroxide, tributylmethylammonium hydroxide, hexamethonium hydroxide, tetramethylammonium carbonate, tetrapropylammonium hydroxide, tetraisopropylammonium hydroxide, tetraisobutylammonium hydroxide, tetra-tert-butylammonium hydroxide, tetrapentylammonium hydroxide, tetraheptylammonium hydroxide, tetraoctylammonium hydroxide, benzyltrimethylammonium hydroxide, diethyldimethylammonium hydroxide, methyltripropylammonium hydroxide, N,N,N,N′,N′,N′-hexabutylhexamethylenediammonium hydroxide, tetrakis(2-hydroxyethyl)ammonium hydroxide, triethylmethylammonium hydroxide, trimethylphenylammonium hydroxide, (2-hydroxyethyl)triethylammonium hydroxide, (2-hydroxyethyl)tripropylammonium hydroxide, (2-hydroxyethyl)tributylammonium hydroxide and dimethyldiethanolammonium hydroxide.

In the process according to the invention, the quaternary ammonium compounds used as catalysts are preferably used in an amount of 0.005% to 2% by weight, more preferably of 0.05% to 1% by weight, based on the sum of compounds of formulae (II), (III) and (IV).

The quaternary ammonium compounds used as catalysts can be employed as a pure substance (solid) or as a solution, for example, in the form of aqueous or alcoholic solutions containing the quaternary ammonium compounds preferably in a concentration of 20% to 50% by weight. Preference is given to using the quaternary ammonium compounds used as catalysts in solid form.

For particular end uses, it may be advantageous when, in addition to the compounds of formula (II) and/or (III), compounds of formula (V)

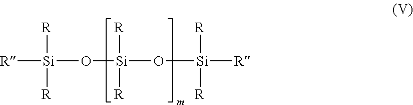

are used, where m and R are each as defined above and R″═OH. However, preference is given to not using such compounds of formula (V).

The feedstocks used, especially compounds (II), (III) and (IV), and the catalyst used, are preferably free (content below the detection limit) of linear dimethylsiloxanes having one or more hydroxyl end groups.

The resulting reaction mixture preferably has a content of linear dimethylsiloxanes having one or more hydroxyl end groups, based on the compounds of formula (I), of less than 15% by weight, preferably less than 5% by weight and especially preferably less than 1% by weight.

It may be advantageous when, in the process according to the invention, one or more compounds selected from the functional silanes and siloxanes are used in addition to the compounds of formulae (II) and/or (III) and optionally (V). Functional silanes/siloxanes are understood to mean those which, in place of aryl, alkyl or methyl groups, or alkoxy groups, have hydrocarbyl radicals having amino groups and/or unsaturated hydrocarbyl radicals. Preferred functional silanes or siloxanes are, for example, 1,3-divinyl-1,1,3,3-tetramethyldisiloxane, 3-aminopropyldiethoxymethylsilane (e.g. Dynasilan® 1505 from Evonik Degussa GmbH) or phenyltrimethoxysilane. Preference is given to using the functional silanes/siloxanes in a mixture with hexamethyldisiloxane as the compound of formula (II).

The process according to the invention is preferably performed batchwise.

The process is preferably performed at a temperature of greater than 70° C. It may be advantageous when the reaction mixture comprising compounds of formulae (II) and/or (III), (IV) and the catalyst is first brought to a temperature T1, and the reaction mixture is held at this temperature for a period Z1 and then brought to a temperature T2 which is at least 10 K, preferably from 25 K to 75 K and preferably from 40 K to 60 K, higher than temperature T1, and is held at this temperature T2 for a period Z2. The temperature T1 is preferably from 75° C. to 125° C., more preferably from 90° C. to 110° C. The period Z1 and/or Z2 is preferably from 1 hour (h) to 24 h, more preferably from 2 h to 10 h and especially preferably from 5 h to 10 h.

It may be advantageous when the reaction mixture obtained after the reaction is distilled. In this way, by-products and unconverted feedstocks can be removed from the reaction mixture. The unconverted feedstocks can, preferably without further purification, be reused as feedstocks in the process according to the invention. The catalyst decomposes within the period Z2 at the temperature T2, and so the decomposition products can be removed from the reaction mixture obtained after the reaction.

When the reaction mixture obtained is distilled, it may be advantageous to perform the distillation at a reduced pressure. Preference is given to performing the distillation at a reduced pressure of less than 60 mbar, preferably less than 10 mbar. The temperature at which the distillation is performed corresponds essentially to the reaction temperature. Preferably the temperature of the distillation is from 10° C.0 to 200° C., especially preferably from 125° C. to 175° C. and most preferably from 140° C. to 160° C.

The compounds of formula (I) prepared in accordance with the invention can be used, for example, for surface treatment, or as additives, for example, in the production of coating materials or polyurethane foams, or for detergent-resistant hydrophobization of coating materials, especially as a car drying aid.

The following examples describe the present invention by way of example, without any intention that the invention, the range of application of which is evident from the overall description and the claims, be restricted to the embodiments mentioned in the examples.

### EXAMPLES

Test Methods:

²⁹Si NMR Measurements:

The ²⁹Si NMR measurements were conducted as described below with an NMR spectrometer with a computer unit and autosampler with a 10 mm sample head from Bruker, 400 MHz, 10 mm QNP, using 10 mm sample tubes and plastic closure caps, both from Novell Inc. The sampling was effected by means of Pasteur pipettes from Brand. The reagents used were: deuterochloroform (CDCl₃) from Deutro, degree of deuteration 99.8%, which had been dried over A3 molecular sieve from Merck.

The measurements were conducted using the measurement parameters specified in Table A:

TABLE A
Measurement parameters for ²⁹Si NMR measurements

| Amount of sample | approx. 1 | g |
|---|---|---|
| CDCl₃ volume | approx. 5 | ml |
| Transmitted frequency | 79.45 | MHz |
| Pulsewidth | 14 | |
| Relaxation time | 5 | sec. |
| Measurement time | 512 | |
| Linewidth | 1 | Hz |

For this purpose, the amount of sample specified was introduced into a clean NMR tube, and the specified volume of CDCl₃ was added. The sample tube was closed with the plastic cap and the sample was homogenized by shaking. Once all air bubbles had separated out at the surface, the sample was analysed in the NMR spectrometer. The assignment of the individual signals is familiar to the person skilled in the art, or can if appropriate be made by comparing with the signals of suitable example substances. The evaluation with regard to the molar ratios of Si—OH groups to Si—O-ethyl groups is effected by finding the ratios of the corresponding integrals of the signals which are assigned to the particular groups.

Viscosity:

The determination of the viscosities was conducted with a Stabinger viscometer (SVM 3000, Anton Paar Germany GmbH) at 25° C. based on DIN 53015.

Determination of the Nitrogen Value:

A sufficient amount of the sample to be analysed, in accordance with the product specification, was weighed accurately to 0.1 mg that a consumption of approx. 10 ml of perchloric acid solution (concentration 0.1 mol/l) was to be expected. This amount was dissolved in approx. 100 ml of tetrahydrofuran. On a Titroprocessor, titration was effected against the 0.1 mol/l perchloric acid solution. Taking account of the consumption of 0.1 mol/l perchloric acid and the starting weight, the content of total base nitrogen or amine number was calculated as follows:

$$\% N = \frac{V * c * M ( N )}{10 * E}$$

where
V=consumption of 0.1 mol/l perchloric acid solution (in ml)
C=concentration of the perchloric acid solution (0.1 mol/l)
M (N)=molar mass of nitrogen (14.0 g/mol)
E=starting weight (in g).

Feedstocks:

Cyclics: technical-grade mixture consisting of octamethylcyclotetrasiloxane (D4)/decamethylcyclopentasiloxane (D5), sold as 244 Fluid by Dow Corning.
Ethanol: Ethanol purissimum, Merck
n-Butanol: >99%, European Oxo GmbH
TMAH*5H₂O: tetramethylammonium hydroxide pentahydrate 98%, Sachem

### Polydimethylsiloxane: 2-1273 Fluid, Dow Corning

Silicone oil 1000: 200(R) Fluid 1000 cSt, Dow Corning

### Example 1

### Reaction of Cyclics with Ethanol and Workup of the Reaction Mixture (Inventive)

The feedstocks specified in Table 1 were initially charged while stirring and heated to a temperature of 70° C. After attainment of 70° C., the mixture was stirred for 7 h. This was followed by heating to a temperature of 150° C. and holding the reaction mixture at a temperature of 150° C. for 2 h. Then vacuum was applied and evacuation was effected to a pressure of less than 5 mbar. After the attainment of a vacuum of <5 mbar, extractive distillation was effected for 4 h.

TABLE 1
Formulation for Example 1

| | Molar | | Amount | | Molar | | Starting | |
|---|---|---|---|---|---|---|---|---|
| Substance | mass | | used | | ratio | | weight | |
| Cyclics | 74.1 | g/mol | 5.4 | mol | 4.66 | mol | 400 | g |
| Ethanol | 46 | g/mol | 1.15 | mol | 1 | mol | 53.3 | g |
| Tetramethylam- | | | 1300 | ppm | | | 590 | mg |
| monium | | | | | | | | |
| hydroxide*5H₂O | | | | | | | | |

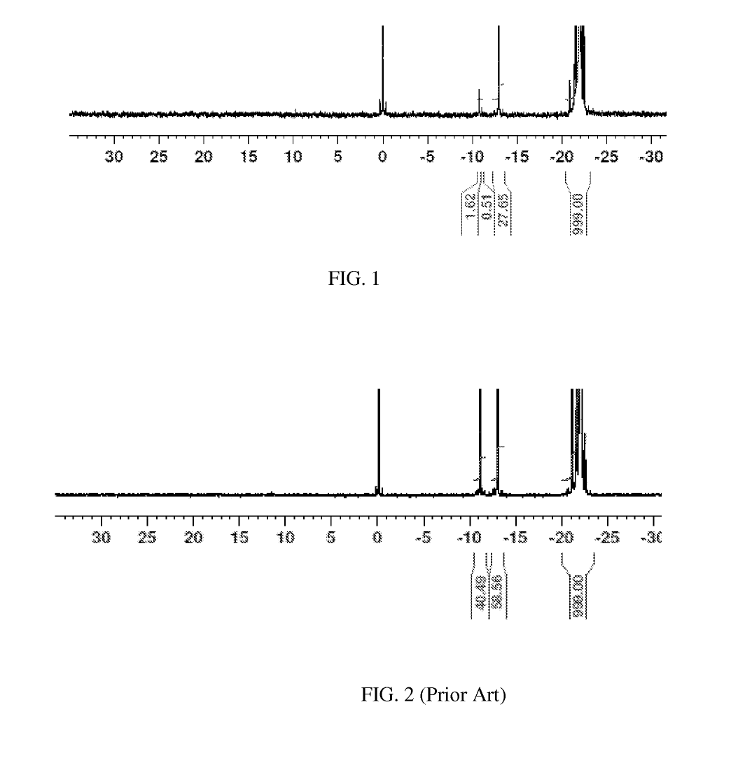

Approx. 107 g (23.6%) of distillate were obtained. The residue of approx. 346.3 g (76.4%) which remains after distillation had a viscosity (determined based on DIN 53015) of 104 mPas. The Si NMR shows essentially a signal at approx. −13 ppm and at −22 ppm. See, for example, the spectra in FIG. 1.

### Example 2

### Reaction of Cyclics with Ethanol and Acidic Workup Based on Novikova et al. in Kauchuk i Rezina (1986), (5), 22-4 (Comparative Example)

The feedstocks specified in Table 2 were initially charged while stirring and heated to a temperature of 70° C. After attainment of 70° C., the mixture was stirred for 7 h. Then the reaction mixture was cooled to 50° C., and 15 g of approx. 20% by weight aqueous acetic acid were added. The mixture was stirred at a temperature of 50° C. for 2 h. Subsequently, 60 g of water were added and the mixture was stirred once again at 50° C. for 1 h.

After cooling to room temperature, the phases were separated in a separating funnel and the nonaqueous phase was washed twice with approx. 60 g of water. After the new phase separation, the combined nonaqueous phases were distilled at a temperature of 150° C. and a pressure of <5 mbar.

TABLE 2
Formulation for Example 2

| | Molar | | Amount | | Starting | |
|---|---|---|---|---|---|---|
| Substance | mass | | used | | weight | |
| Cyclics | 74.1 | g/mol | 4.66 | mol | 345.6 | g |
| Ethanol | 46 | g/mol | 1 | mol | 46 | g |
| Tetramethylammonium | | | 1300 | ppm | 509 | mg |
| hydroxide*5H₂O | | | | | | |
| Approx. 20% aqueous | | | | | 15 | g |
| acetic acid | | | | | | |

Approx. 216.1 g of distillate and 132.7 g (33.9% by weight based on the amounts used) of a residue with a viscosity of 24 mPas were obtained. The ²⁹Si NMR in FIG. 2 shows a signal at approx. −11 ppm and at −13 ppm (in a ratio of 40:58) and at −22 ppm.

Comparison of the two spectra shows clearly that the product obtained from the comparative example had a strong signal at a shift of −11 ppm which was caused by the Si—OH group. This signal was much smaller in the reaction product of the process according to the invention. A comparison of the area integrals leads to a molar ratio of the Si—O-ethyl groups to the Si—OH groups of 13:1 for Example 1 and of 1.4:1 for Example 2. From these ratios, it was evident that the process according to the invention in Example 1 avoids the formation of SiOH groups, while Comparative Example 2 affords an almost equal number of Si—OH groups and Si—O-ethyl groups.

### Example 3

### Reaction of C₄-Alcohols with Different Siloxane Compounds of the Formula (II) and/or (III), Inventive

In the particular experiments, the feedstocks specified in Table 3 were initially charged in the amounts specified therein and heated to a temperature of 100° C. After attainment of 100° C., the mixture was stirred for 7 h. This was followed by heating to a temperature of 150° C. and holding of the reaction mixture at a temperature of 150° C. for 2 h. Then vacuum was applied and evacuation was effected to a pressure of less than 5 mbar. After the attainment of a vacuum of <5 mbar, the mixture was distilled for 4 h.

TABLE 3
Formulations and results of the tests for Example 3

| | | | | | | | Residue | Viscosity |
|---|---|---|---|---|---|---|---|---|
| | | | | | | | after | of the |
| EXPERIMENT | Feedstocks | Amount | | Mols | | Distillate | distillation | residue |
| 3.1 | cyclics | 150 | g | 2.02 | mol | 300 g = | 0 g | — |
| CC 1727 | n-butanol | 150 | g | 2.02 | mol | 100% | (0%) | |
| | no catalyst | 0 | | 0 | | | | |
| 3.2 | cyclics | 150 | g | 2.02 | mol | 0% | 100% | gellates |
| H2529 | no alcohol | 0 | g | 0 | mol | | | |
| | TMAH*5H₂O | 150 | mg | 1000 | ppm | | | |
| 3.3 | cyclics | 400 | g | 5.41 | mol | 451.87 g = | 348.13 g | 11 mPas |
| CC 1719 | n-butanol | 400 | g | 5.41 | mol | 56.5% | (43.5%) | |
| | TMAH*5H₂O | 800 | mg | 1000 | ppm | | | |
| 3.4 | cyclics | 250 | g | 3.37 | mol | 80.75 g = | 219.25 g | 34 mPas |
| CC 1753 | n-butanol | 50 | g | 0.67 | mol | 26.9% | (73.1%) | |
| | TMAH*5H₂O | 300 | mg | 1000 | ppm | | | |
| 3.5 | cyclics | 50 | g | 0.67 | mol | 269.77 g = | 30.23 g | 4 mPas |
| CC 1755 | n-butanol | 250 | g | 3.37 | mol | 89.9% | (10.1%) | |
| | TMAH*5H₂O | 300 | mg | 1000 | ppm | | | |
| 3.6 | cyclics | 75 | g | 1.01 | mol | 164.61 g = | 135.39 g | 11 mPas |
| CC 1802 | PDM siloxan | 75 | g | 0.02 | mol | (54.9%) | (45.1%) | |
| | n-butanol | 150 | g | 2.02 | mol | | | |
| | TMAH*5H₂O | 300 | mg | 1000 | ppm | | | |
| 3.7 | silicone oil 1000 | 150 | g | 0.007 | mol | 165.89 g | 134.11 g | 11 mPas |
| CC 1741 | n-butanol | 150 | g | 2.02 | mol | (55.3%) | (44.7%) | |
| | TMAH*5H₂O | 300 | mg | 1000 | ppm | | | |
| 3.8 | cyclene mixture | 150 | g | 2.02 | mol | 163.92 g = | 136.08 g | 23 mPas |
| CC 1733 | 2-butanol | 150 | g | 2.02 | mol | 54.6% | (45.4%) | |
| | TMAH*5H₂O | 300 | mg | 1000 | ppm | | | |
| 3.9 | cyclics | 150 | g | 2.02 | mol | 164.62 g = | 135.38 g | 17 mPas |
| CC 1766 | 2-methylpropanol | 150 | g | 2.02 | mol | 54.9% | (45.1%) | |
| | TMAH*5H₂O | 300 | mg | 1000 | ppm | | | |
| 3.10 | cyclics | 150 | g | 2.02 | mol | 181.03 g = | 118.97 g | 5897 mPas |
| CC 1752 | tert-butanol | 150 | g | 2.02 | mol | 60.3% | (39.7%) | |
| | TMAH*5H₂O | 300 | mg | 1000 | ppm | | | |
| 3.11 | cyclics | 150 | g | 2.02 | mol | 247.13 g = | 52.87 g | 8 mPas |
| CC 1728 | n-butanol | 150 | g | 2.02 | mol | 82.4% | (17.6%) | |
| | tetraethylammonium | 300 | mg | 1000 | ppm | | | |
| | hydroxide (TEAH) | | | | | | | |
| 3.12 | cyclics | 150 | g | 2.02 | mol | 167.91 g = | 132.09 g | 11 mPas |
| CC 1736 | n-butanol | 150 | g | 2.02 | mol | 56.0% | (44.0%) | |
| | TMAH 25% solution in | 300 | mg | 1000 | ppm | | | |
| | H₂O | | | | | | | |
| 3.13 | cyclics | 150 | g | 2.02 | mol | 179.85 g = | 120.15 g | 10 mPas |
| CC 1737 | n-butanol | 150 | g | 2.02 | mol | 59.9% | (40.1%) | |
| | TMA siloxanolate | 300 | mg | 1000 | ppm | | | |
| 3.14 | cyclics | 150 | g | 2.02 | mol | 169.6 g | 130.4 g | 12 mPas |
| CC 1738 | n-butanol | 150 | g | 2.02 | mol | (56.5%) | (43.5%) | |
| | TMAH 25% solution in | 300 | mg | 1000 | ppm | | | |
| | methanol | | | | | | | |
| 3.15 | cyclics | 150 | g | 2.02 | mol | 167.71 g = | 132.29 g | 11 mPas |
| CC 1761 | n-butanol | 150 | g | 2.02 | mol | 55.9% | (44.1%) | |
| | tetrabutylammonium | 300 | mg | 1000 | ppm | | | |
| | hydroxide | | | | | | | |
| 3.16 | cyclics | 150 | g | 2.02 | mol | 220.37 g = | 79.63 g | 9 mPas |
| CC 1762 | n-butanol | 150 | g | 2.02 | mol | 73.5% | (26.5%) | |
| | tetrahexylammonium | 300 | mg | 1000 | ppm | | | |
| | hydroxide | | | | | | | |
| 3.17 | cyclics | 150 | g | 2.02 | mol | 237.6 g = | 62.4 g | 9 mPas |
| CC 1751 | n-butanol | 150 | g | 2.02 | mol | 79.2% | (20.8%) | |
| | choline hydroxide 25% ig | 300 | mg | 1000 | ppm | | | |
| 3.18 | cyclics | 150 | g | 2.02 | mol | 176.12 g = | 123.88 g | 11 mPas |
| CC 1763 | n-butanol | 150 | g | 2.02 | mol | 58.7% | (41.3%) | |
| | tributylmethylammonium | 300 | mg | 1000 | ppm | | | |
| | hydroxide | | | | | | | |
| 3.19 | cyclics | 150 | g | 2.02 | mol | 255.16 g = | 44.84 g | 8 mPas |
| CC 1765 | n-butanol | 150 | g | 2.02 | mol | 85.1% | (14.9%) | |
| | hexamethonium | 300 | mg | 1000 | ppm | | | |
| | hydroxide | | | | | | | |
| 3.20C | cyclics | 150 | g | 2.02 | mol | 300 g = | 0 g | — |
| CC 1739 | n-butanol | 150 | g | 2.02 | mol | (100%) | (0%) | |
| | TMA bromide | 300 | mg | 1000 | ppm | | | |
| 3.21C | cyclics | 150 | g | 2.02 | mol | 299.81 g = | 0.19 g | — |
| CC 1742 | n-butanol | 150 | g | 2.02 | mol | 99.9% | (0.1%) | |
| | TMA formate solution; | 300 | mg | 1000 | ppm | | | |
| | 30% in H₂O | | | | | | | |
| 3.22C | cyclics | 150 | g | 2.02 | mol | 299.61 g = | 0.39 g | — |
| CC 1743 | n-butanol | 150 | g | 2.02 | mol | 99.9% | (0.1%) | |
| | TMA iodide | 300 | mg | 1000 | ppm | | | |
| 3.23C | cyclics | 150 | g | 2.02 | mol | 299.94 g = | 0.06 g | — |
| CC 1744 | n-butanol | 150 | g | 2.02 | mol | 99.98% | (0.02%) | |
| | TMA tetrafluoroborate | 300 | mg | 1000 | ppm | | | |
| 3.24C | cyclics | 150 | g | 2.02 | mol | 299.4 g = | 0.6 g | — |
| CC 1745 | n-butanol | 150 | g | 2.02 | mol | 99.8% | (0.2%) | |
| | TMA hydrogenphthalate | 300 | mg | 1000 | ppm | | | |
| 3.25C | cyclics | 150 | g | 2.02 | mol | 298.7 g = | 1.3 g | — |
| CC 1750 | n-butanol | 150 | g | 2.02 | mol | 99.6% | (0.4%) | |
| | choline acetate | 300 | mg | 1000 | ppm | | | |
| 3.26C | cyclics | 150 | g | 2.02 | mol | 293.87 g = | 6.13 g | — |
| CC 1764 | n-butanol | 150 | g | 2.02 | mol | 98% | (2%) | |
| | tetramethylammonium | 300 | mg | 1000 | ppm | | | |
| | acetate | | | | | | | |

A distillate was obtained, which was weighed. The residue was weighed and then the viscosity of the residue was determined. The measurements determined can be found in Table 3.

Examples 3.20C to 3.26C serve as comparative examples. These comparative examples show that the selection of a suitable catalyst is crucial for the success of the reaction performed by the process according to the invention.

### Example 4

### Reaction of Various Alcohols with Various Siloxane Compounds of the Formula (II) and/or (III), Inventive

In the particular experiments, the feedstocks specified in Table 4 were initially charged in the amounts specified therein and these mixtures were heated to a temperature of 100° C. while stirring. After attainment of 100° C., the mixture was stirred for 7 h. This was followed by heating to a temperature of 150° C. and holding of the reaction mixture at a temperature of 150° C. for 2 h. A vacuum was then applied and evacuation was effected to a pressure of <5 mbar. After the attainment of a vacuum of <5 mbar, distillation was effected for 4 h.

TABLE 4
Formulations and results of the experiments for Example 4

| | | | | | Total | Residue | Viscosity of |
|---|---|---|---|---|---|---|---|
| Batch | Feedstocks | Amount | Mols | | distillate | (yield) | the residue |
| 4.1 | cyclics | 150 g | 2.02 | mol | 222.77 g = | 77.23 g | 49 mPas |
| CC 1747 | 1,2-butanediol | 150 g | 1.66 | mol | 74.3% | (25.7%) | |
| | TMAH*5H₂O | 300 mg | 1000 | ppm | | | |
| 4.2 | cyclics | 150 g | 2.02 | mol | 220.84 g = | 79.16 g | 636 mPas |
| CC 1756 | 1,3-butanediol | 150 g | 1.66 | mol | 73.6% | (26.4%) | |
| | TMAH*5H₂O | 300 mg | 1000 | ppm | | | |
| 4.3 | cyclics | 400 g | 5.4 | mol | 570.1 g = | 379.3 g | 23.9 mPas |
| U 4069 | 2-phenoxyethanol | 400 g | 2.90 | mol | 60% | (40%) | |
| | TMAH*5H₂O | 0.8 g | 1000 | ppm | | | |

A distillate was obtained, which was weighed. The residue was weighed and then the viscosity of the residue was determined (based on DIN 53015). The measurements obtained can be found in Table 4.

### Example 5

### Reaction of C₄ Monoalcohols with Various Siloxane Compounds of the Formula (II) and/or (III) with Addition of Functionalized Silanes and/or Siloxanes, Inventive

In the particular experiments, the feedstocks specified in Table 5 were initially charged in the amounts specified therein and this mixture was heated to a temperature of 100° C. After attainment of 100° C., the mixture was stirred for 7 h. This was followed by heating to a temperature of 150° C. and holding of the reaction mixture at a temperature of 150° C. for 2 h. A vacuum was then applied by means of an oil pump and a pressure of less than 5 mbar was established. After the attainment of a vacuum of <5 mbar, distillation was effected for 4 h.

TABLE 5
Formulations and results of the experiments for Example 5

| | | | | | | Total | Residue | Viscosity of |
|---|---|---|---|---|---|---|---|---|
| Batch | Feedstocks | Amount | | Mols | | distillate | (yield) | the residue |
| 5.1 | Cyclics | 350 | g | 4.73 | mol | 428.5 g = | 307.2 g | 8 mPas |
| H 2520 | n-butanol | 350 | g | 4.73 | mol | 58.2% | (41.8%) | |
| | 1,3-divinyl-1,1-3,3- | 35 | g | 0.188 | mol | | | |
| | tetramethyldisiloxane | | | | | | | |
| | TMAH*5H₂O | 735 | mg | 1000 | ppm | | | |
| 5.2 | Cyclics | 350 | g | 4.73 | mol | 380.35 g = | 355.39 g | 10 mPas |
| H 2522 | n-butanol | 350 | g | 4.73 | mol | 51.7% | (48.3%) | |
| | phenyltrimethoxysilane | 35 | g | 0.176 | mol | | | |
| | TMAH*5H₂O | 735 | mg | 1000 | ppm | | | |
| 5.3 | Cyclics | 350 | g | 4.73 | mol | 384.4 g = | 354.73 g | 11 mPas |
| H 2523 | n-butanol | 350 | g | 4.73 | mol | 52% | (48.0%) | |
| | phenyltrimethoxysilane | 35 | g | 0.176 | mol | | | |
| | Hexamethyldisiloxane | 3.5 | g | 0.022 | mol | | | |
| | TMAH*5H₂O | 738 | mg | 1000 | ppm | | | |

A distillate was obtained, which was weighed. The residue was weighed and then the viscosity of the residue was determined. The measurements determined can be found in Table 5.

### Example 6

### Reaction of Various Amino Alcohols with Various Siloxane Compounds of the Formula (II) and/or (III), Inventive

In the particular experiments, the feedstocks specified in Table 6 were initially charged in the amounts specified therein and these mixtures were heated to a temperature of 100° C. while stirring and held at this temperature for 7 h. This was followed by heating to a temperature of 150° C. and holding of the reaction mixture at a temperature of 150° C. for 2 h. A vacuum was then applied by means of an oil pump and a pressure of less than 5 mbar was established. After the attainment of a vacuum of <5 mbar, the mixture was distilled for 4 h.

TABLE 6
Formulations and results of the experiments for Example 6

| | | | | | | | Viscosity | |
|---|---|---|---|---|---|---|---|---|
| | | | | | Total | Residue | of the | Nitrogen |
| Batch | Feedstocks | Amount | Mols | | distillate | (yield) | residue | value found |
| 6.1 | Cyclics | 2000 g | 27 | mol | 1226.8 g = | 1721 g = | 33 mPas | 1.40% |
| TR- | n-butylaminoethanol | 1000 g | 8.53 | mol | 40.9% | 57.4% | | |
| 2241 | TMAH*5H₂O | 3 g | 1000 | ppm | | | | |
| 6.2 | Cyclics | 2500 g | 33.7 | mol | 809.3 g = | 2153.2 g = | 68 mPas | 0.79% |
| TR- | n-butylaminoethanol | 500 g | 4.27 | mol | 27.0% | 71.8% | | |
| 2242 | TMAH*5H₂O | 3 g | 1000 | ppm | | | | |
| 6.3 | Cyclics | 2500 g | 33.7 | mol | 715.2 g = | 2239 g = | 68 mPas | 0.65% |
| TR- | N,N- | 500 g | 5.61 | mol | 23.8% | 74.6% | | |
| 2245 | dimethylethanolamine | | | | | | | |
| | TMAH*5H₂O | 3 g | 1000 | ppm | | | | |
| 6.4 K | Cyclics | 2000 g | 27.04 | mol | 1177 g = | 1781.4 g | 28 mPas | 1.42% |
| 1883 | N,N- | 1000 g | 11.22 | mol | 39.2% | (59.3%) | | |
| | dimethylethanolamine | | | | | | | |
| | TMAH*5H₂O | 3 g | 1000 | ppm | | | | |

A distillate was obtained, which was weighed. The residue was weighed and then the viscosity and the nitrogen value of the residue were determined. The measurements can be found in Table 6.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A process for preparing compounds of formula (I) 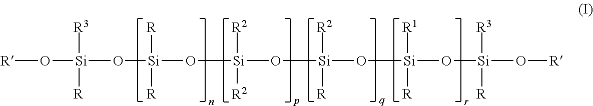
by reacting linear siloxane compounds (II) 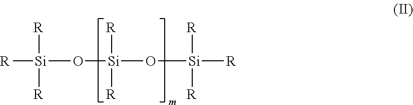
and/or cyclic siloxane compounds (III) 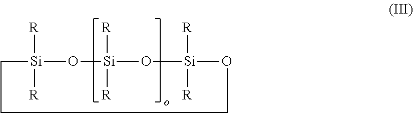
with a compound (IV) having at least one hydroxyl group
R′—OH (IV)
where
each R is the same or different and is a saturated or unsaturated hydrocarbyl radical,
each R′ is the same or different and is an organic radical, where the two R′ radicals shown in formula (I) may also be a single organic radical, 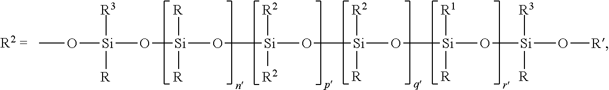
each R³ is the same or different and is R or R¹,
each R¹ is the same or different and is an alkoxy radical, a hydrocarbyl radical having amino groups and/or an unsaturated hydrocarbyl radical,
n=0 to 1000,
m=0 to 1000,
o=1 to 5,
p=0 to 10,
q=0 to 10,
r=0 to 20,
n′=0 to 1000,
p′=0 to 10,
q′=0 to 10,
r′=0 to 20,
with the proviso that the sum of all units with the indices p, q, p′ and q′ is not greater than 15,
in the presence of one or more catalysts selected from quaternary ammonium compounds which have, as anion(s), a carbonate, siloxanolate or hydroxide anion, wherein the compounds of formulae (II), (III) and (IV) are used in such amounts that the molar ratio of silicon atoms in the compounds of formulae (II) and (III) to OH groups in the compounds of formula (IV) is from 0.01:1 to 1000:1, and at a temperature of greater than 70° to 175° C., and wherein no acidic compound is employed.

2. The process according to claim 1, wherein the quaternary ammonium compounds are selected from the group consisting of tetramethylammonium hydroxide, tetramethylammonium hydroxide*5H₂O, tetrabutylammonium hydroxide, choline hydroxide, tetramethylammonium siloxanolate, tetrahexylammonium hydroxide, tetraethylammonium hydroxide, tributylmethylammonium hydroxide, hexamethonium hydroxide, tetramethylammonium carbonate, tetrapropylammonium hydroxide, tetraisopropylammonium hydroxide, tetraisobutylammonium hydroxide, tetra-tert-butylammonium hydroxide, tetrapentylammonium hydroxide, tetraheptylammonium hydroxide, tetraoctylammonium hydroxide, benzyltrimethylammonium hydroxide, diethyldimethylammonium hydroxide, methyltripropylammonium hydroxide, N,N,N,N′,N′,N′-hexabutylhexamethylenediammonium hydroxide, tetrakis(2-hydroxyethyl)ammonium hydroxide, triethylmethylammonium hydroxide, trimethylphenylammonium hydroxide, (2-hydroxyethyl)triethylammonium hydroxide, (2-hydroxyethyl)tripropylammonium hydroxide, (2-hydroxyethyl)tributylammonium hydroxide and dimethyldiethanolammonium hydroxide.

3. The process according to claim 1, wherein the quaternary ammonium compounds are used in an amount of 0.05 to 1% by weight based on the sum of the compounds of formulae (II), (III) and (IV).

4. The process according to claim 1, wherein the quaternary ammonium compounds are aqueous or alcoholic solutions containing the quaternary ammonium compounds in a concentration of 20 to 50% by weight, or solids.

5. The process according to claim 1, wherein the compounds (IV) are those in which the hydroxyl group is a primary or secondary hydroxyl group.

6. The process according to claim 1, wherein the compounds (IV) are compounds selected from the group consisting of saturated or unsaturated monoalcohols having 2 to 30 carbon atoms, saturated or unsaturated di- or polyols having 2 to 20 carbon atoms and amino alcohols having 2 to 20 carbon atoms.

7. The process according to claim 1, wherein the compounds (IV) are ethanol, propanol, n-butanol, 2-butanol, 2-methylpropanol, N-butylaminoethanol, N,N-dimethylethanolamine, 1,2-butanediol, 1,3-butanediol, 2-phenoxyethanol, ethanolamine or mixtures thereof.

8. The process according to claim 1, wherein a reaction mixture comprising compounds of formulae (II) and/or (III), (IV) and the catalyst is first brought to a temperature T1, and the reaction mixture is held at T1 for a period Z1 and then brought to a temperature T2 which is at least 10 K, higher than temperature T1, and is held at T2 for a period Z2.

9. The process according to claim 8, wherein T1 is from 75° C. to 125° C.

10. The process according to claim 8, wherein at least one of Z1 and Z2 is from 1 h to 24 h.

11. The process according to claim 1, further comprising distilling the reaction mixture obtained after said reacting.

12. The process according to claim 1, the compounds of formulae (II), (III) and (IV) and the catalyst are free of linear dimethylsiloxanes having hydroxyl end groups.

13. The process according to claim 1, further comprising a functional silane and/or siloxane other than the compounds of the formulae (II) and (III) employed in said reacting.
